(19) United States
(12) Patent Application Publication
(10) Pub. No.: US 2026/0148006 A1
(43) Pub. Date: May 28, 2026

(54) INTELLIGENTLY SUMMARIZING AND PRESENTING TEXTUAL RESPONSES WITH MACHINE LEARNING

(71) Applicant: Qualtrics, LLC, Provo, UT (US)

(72) Inventors: Daniel Perry, Reston, VA (US); Mark Arehart, Reston, VA (US); Yasaman Haghpanah, Reston, VA (US); Vidhi Gupta, Reston, VA (US); Zhengzheng Xing, Seattle, WA (US); Nikhil Kamath, Seattle, WA (US)

(21) Appl. No.: 18/962,421

(22) Filed: Nov. 27, 2024

(51) Int. Cl. G06F 40/30; G06T 11/20

(52) U.S. Cl. CPC G06F 40/30; G06T 11/26

(57) ABSTRACT

This disclosure relates to methods, non-transitory computer readable media, and systems apply machine-learning techniques and computational analysis to extract topics from textual content and reconnect the textual content with the extracted topics. To illustrate, the disclosed systems utilize a topic generation model to generate a topic data structure (including extracted topics and associated keywords) from unstructured text based on underlying themes within the unstructured text. Furthermore, the disclosed systems utilize a reverb correlation model to reconnect the unstructured text to the extracted topics by determining correlations between the text and the extracted topics. Additionally, in certain embodiments, the disclosed systems utilize a reverb correlation model (and/or additional models) to provide detailed explanations of the reasons particular text is correlated with particular topics.

### BACKGROUND

Recent years have seen significant improvements in computer hardware and software platforms utilizing natural language processing to evaluate textual content. For example, the widespread use of computing devices and the expanding capabilities of computer systems have resulted in a continuous need to evaluate digital content across various applications and formats. Consequently, due to the vast amount of digital content available, different content analysis systems have been developed to analyze and organize the digital content. Despite the advancements of existing content analysis systems, current systems frequently exhibit technological limitations that give rise to several shortcomings, especially when it comes to offering an efficient and versatile analysis function for extracting topics from unstructured text while maintaining a correlation between the topics and the unstructured text.

As just suggested, existing content analysis systems are often inaccurate. For example, current content analysis systems attempt to determine topics from textual content, such as articles, social media posts, survey responses, conversations, reviews, and social posts. However, these current content analysis systems typically generate topics without maintaining a clear and explicit connection to the textual content from which the topics were derived. For example, while some current content analysis systems can identify topics within text, current content analysis systems frequently fail to delineate how these topics relate to particular portions of the content. Indeed, many current content analysis systems fail to accurately reconnect the textual content with the generated topics due to a lack of contextual understanding necessary to accurately map the relevant parts of the text to the topics.

Moreover, current content analysis systems are often rigid. For example, current content analysis systems often rely on predefined categories and superficial keyword associations, which do not adapt well to evolving or emerging topics. This rigidity of current content analysis systems can result in irrelevant or incorrect associations between the text and the generated topics. Consequently, the analysis of current content analysis systems can be inconsistent, causing traditional content analysis systems to inaccurately correlate unrelated topics due to a reliance on keyword matching rather than a deeper semantic understanding.

In addition, many existing content analysis systems are inefficient, both in terms of computing resources as well as through client device interactions. For example, in part due to the loss of connections between topics and textual content, many current content analysis systems introduce excess processing requirements. In particular, current content analysis systems waste computing resources attempting to connect textual content to topics that are unrelated to the textual content. To illustrate, many current content analysis systems expend significant processing bandwidth and memory trying to match textual content to outdated or irrelevant topics, often predefined in isolation from the actual textual content. Furthermore, as mentioned, current content analysis systems often associate textual content with topics without accurately evaluating the context, leading to incorrect correlations. As a result, current content systems require additional processing time to reconcile mismatches between topics and textual content, leading to slower computing performance and the use of additional system resources.

Relatedly, current content analysis systems cause user devices to navigate through multiple interfaces and perform additional searches to establish relationships between textual content and topics. Without direct connections to particular textual content, the current content analysis systems require user devices to perform additional search queries to extract the necessary contextual information. As a result, current content analysis systems provide a cumbersome user device interface that requires excess device interactions.

### BRIEF SUMMARY

This disclosure describes one or more embodiments of methods, non-transitory computer readable media, and systems that solve the foregoing problems in addition to providing other benefits. For example, the disclosed systems utilize a topic generation model to extract topics from textual content and utilize a reverb correlation model to reconnect the textual content with the extracted topics. To illustrate, the disclosed systems utilize the topic generation model to extract topics from input verbatims (e.g., unstructured text) by determining underlying themes within the verbatims. In some embodiments, the disclosed systems utilize the topic generation model to generate a data structure which associates the extracted topics with keywords. In addition, in some embodiments, the topic generation model generates additional contextual information associated with the topics including summaries, comments, examples, descriptions, and sentiments.

As mentioned, in certain embodiments, the disclosed systems utilize a reverb correlation model to reconnect (e.g., generate correlations for) the verbatims to the topics extracted from the verbatims. In some cases, the disclosed systems improve the ability of the reverb correlation model to recognize and evaluate the correlations between topics and verbatims by fine-tuning the reverb correlation model. Additionally, in certain embodiments, the disclosed systems utilize the reverb correlation model (and/or additional models) to provide detailed explanations of the reasons specific verbatims are correlated with specific topics.

### BRIEF DESCRIPTION OF THE DRAWINGS

The detailed description refers to the drawings briefly described below.

FIG. 1 illustrates a block diagram of an environment in which a verbatim classification system can operate in accordance with one or more embodiments.

FIG. 2 illustrates a verbatim classification system applying a topic generation model and a reverb correlation model to generate verbatim correlations in accordance with one or more embodiments.

FIG. 3 illustrates a topic generation model generating a topic data structure in accordance with one or more embodiments.

FIG. 4 illustrates a reverb correlation model generating verbatim correlations in conjunction with a reverb association model generating associated explanations in accordance with one or more embodiments.

FIG. 5 illustrates training a reverb correlation model to recognize connections between topics and verbatims in accordance with one or more embodiments.

FIG. 6 illustrates utilizing a zero-shot semantic similarity classification model to determine correlations between topics and verbatims in accordance with one or more embodiments.

FIGS. 7A-7B illustrate utilizing a computing device to display generated topics within a graphical user interface in accordance with one or more embodiments.

FIG. 7C illustrates utilizing a verbatim classification system to display correlations between verbatims and topics in accordance with one or more embodiments.

FIG. 7D illustrates utilizing a verbatim classification system to display a heatmap representing correlations between a verbatim and a topic in accordance in accordance with one or more embodiments.

FIG. 7E illustrates utilizing a verbatim classification system to display an explanatory report for correlations between a verbatim and a topic in accordance with one or more embodiments.

FIG. 8 illustrates a flowchart of a series of acts for assigning a topic to a verbatim in accordance with one or more embodiments.

FIG. 9 illustrates a block diagram of a computing device in accordance with one or more embodiments.

FIG. 10 illustrates a network environment of a verbatim classification system in accordance with one or more embodiments.

### DETAILED DESCRIPTION

This disclosure describes embodiments of a verbatim classification system utilizing a multi-model approach to extract topics from natural language textual content (e.g., verbatims, unstructured user input) and to reconnect the natural language textual content to the topics extracted from the natural language textual content. For example, the verbatim classification system utilizes a topic generation model to extract topics from a group of verbatims based on underlying themes. The verbatim classification system utilizes a reverb correlation model to establish (or re-establish) correlations by reconnecting the extracted topics to the verbatims based on semantic similarities between the verbatims and the topics. By using this multi-model approach, the verbatim classification system generates correlations between verbatims and topics utilizing an enhanced understanding of the correlations between the topics and the verbatims over existing content analysis systems.

As mentioned above, in some embodiments, the verbatim classification system generates topics by determining underlying themes for the input verbatims. In particular, the verbatim classification system provides a custom prompt to instruct the topic generation model to analyze the input verbatims and generate a topic data structure that includes topics and associated keywords based on the underlying themes of the input verbatims. In addition, in some embodiments, the verbatim classification system provides the custom prompt to cause the topic generation model to generate additional content associated with the topics including descriptions, summaries, examples, and sentiments.

In some cases, the topic generation model can refine the topic data structure. For example, the topic generation model can customize the topic data structure using predefined suggestions or topic filters for the topics. In some cases, the topic generation model customizes the topics by selecting a subset of the topics based on a relative semantic similarity of the topics to the input verbatims. In some cases, the topic generation model narrows (collapses) or broadens (expands) the topics to satisfy varying levels of detail required by the verbatim classification system. To narrow or expand the topics, the verbatim classification system can refine the topic data structure by iteratively providing the topics to the topic generation model.

Furthermore, the verbatim classification system can improve system performance and versatility by processing the verbatims in batches. For example, the verbatim classification system can determine subsets of verbatims from the input verbatims (e.g., one, two, three or more subsets) and separately generate subsets of topics for the subsets of verbatims. In addition to generating the subsets of topics, the verbatim classification system can combine the subsets of topics to generate a combined set of topics. To refine the combined set of topics, the verbatim classification system optionally filters the combined set of topics to remove duplicate or excess topics (e.g., deduping).

As suggested above, the verbatim classification system can update the topics based on evolving system requirements. For instance, the verbatim classification system can update the topics by updating the topic data structure based on receiving additional verbatims and providing the additional verbatims to the topic generation model. In some cases, the verbatim classification system can determine that a change in the volume of verbatims (e.g., a percentage change in volume) satisfies a change threshold and cause the topic generation model to update the topic data structure based on satisfying the change threshold. In some cases, the verbatim classification system can update the topics based on assessing a topic relevancy, a success of the correlations, a passage of time, a system change, or other factors.

In addition to determining the topics, in some cases, the verbatim classification system determines a correlation between verbatims and topics of the topic data structure. For example, in some cases, the topic generation model generates topics that are disconnected from the input verbatims (e.g., are not specifically connected to individual input verbatims). In certain implementations, the verbatim classification system utilizes a reverb correlation model to establish (or re-establish) correlations between the input verbatims and the topics of the topic data structure. For example, in some cases, the verbatim classification system utilizes a zero-shot model, a sematic similarity model, a large language model, a cross encoder model, a retriever model, and/or other models as the reverb correlation model.

In addition to determining the correlations, in some embodiments, the verbatim classification system utilizes the reverb correlation model to assign the topics to verbatims. For example, the reverb correlation model assigns topics to the input verbatims by utilizing the correlations between the input verbatims and the topics to connect the input verbatims to the topics. In some cases, the reverb correlation model assigns multiple topics to an individual verbatim and vice versa. In some cases, the verbatim classification system determines a correlation between the verbatims and the topics based on a threshold semantic similarity metric representing the semantic relevance of the topic to the verbatim. Based on the threshold semantic similarity metric satisfying a threshold semantic similarity, the verbatim classification system assigns the topics (one or more) to the verbatims (one or more).

In some cases, the reverb correlation model assigns topics to additional verbatims. For example, the reverb correlation model can determine correlations for additional verbatims that were not used to generate the topics. In particular, the reverb correlation model can assign topics to the additional verbatims by determining correlations between the additional verbatims and the topics to connect the additional verbatims to the topics.

In some embodiments, the verbatim classification system trains the reverb correlation model to recognize correlations between topics and verbatims. For instance, in certain implementations, the verbatim classification system trains the reverb correlation model to recognize correlations between topics and verbatims based on semantic associations between the verbatims and the topics. Furthermore, in one or more embodiments, the verbatim classification system selects and trains the reverb correlation model based on a target language.

As noted above, in certain implementations, the verbatim classification system provides data and analytics for display within a graphical user interface. For example, the verbatim classification system provides data and analytics based on the correlations between the topics and the verbatims. In some cases, the verbatim classification system utilizes a reverb association model (and/or the reverb correlation model) to generate explanatory data for the correlations. In some cases, the verbatim classification system provides a heatmap representing the correlations between the verbatims and the topics for display on a client device. In some cases, the verbatim classification system provides an explanatory report including reasons the topics (or topic) are assigned to the verbatims (or verbatim).

As suggested above, the verbatim classification system provides several advantages over current content analysis systems. In particular, the verbatim classification system enhances accuracy over current content analysis systems by generating more accurate correlations between verbatims and topics. By utilizing natural language processing techniques and custom prompts, embodiments of the verbatim classification system tailor the topic generation model to create topic data structures that more accurately reflect the underlying themes of the input verbatims. Moreover, the verbatim classification system dynamically updates the topics based on updates to the verbatims or changing system need, to ensure the correlations remain accurate.

Furthermore, instead of relying on a superficial match of verbatims to keywords, the verbatim classification system correlates the topics with the verbatims based on a semantic similarity analysis. For example, utilizing a topic generation model, the verbatim classification system generates additional content such as summaries, examples, descriptions, and sentiments associated with the topics to more accurately generate the correlations between the verbatims and the topics. Moreover, rather assigning verbatims to a set of rigid predefined topics, the verbatim classification system accurately generates relevant topics directly from pertinent verbatims. Relatedly, the verbatim classification system allows for the expansion or contraction of topics, adapting to more accurately reflect specific system requirements.

In addition, the verbatim classification system provides several technical efficiencies over current content analysis systems. For example, the correlations generated by the verbatim classification system eliminate the need for subsequent processes to reconnect the topics with the verbatims, unlike current content analysis systems where topics are generated in isolation. Furthermore, the verbatim classification system uses real-time updates to ensure that correlations between verbatims and topics remain current without requiring excess processing cycles to reconcile mismatches. Additionally, embodiments of the verbatim classification system use batch processing techniques to analyze large volumes of verbatims efficiently, reducing the computational load on the system. Moreover, by expanding or contracting topics to adapt to the specific analytical needs of the system, the verbatim classification system reduces needless calculations and further optimizes processing time. Indeed, based on these and other efficiencies, the verbatim classification system can process large datasets more quickly and efficiently, requiring less system bandwidth and/or memory.

Moreover, the verbatim classification system solves specific technical problems that arose in the technical field of unstructured text categorization and classifications. In particular, models that are used to generate topics for unstructured text create the specific problem of generating an accurate topic, however, the model inherently generates the topic in a way that is disassociated with the verbatim due to the nature of the models used to generate the topic. This disassociation problem is a technical problem that specifically arises in topic generation models. As mentioned above, and as described more fully below, the verbatim classification system can utilize a data structure and/or additional specially trained models to establish a correlation between a verbatim and the generated topic or theme. These correlations are then used by the verbatim classification system to solve the disassociation problem by associating verbatims with the topics based on the determined correlations.

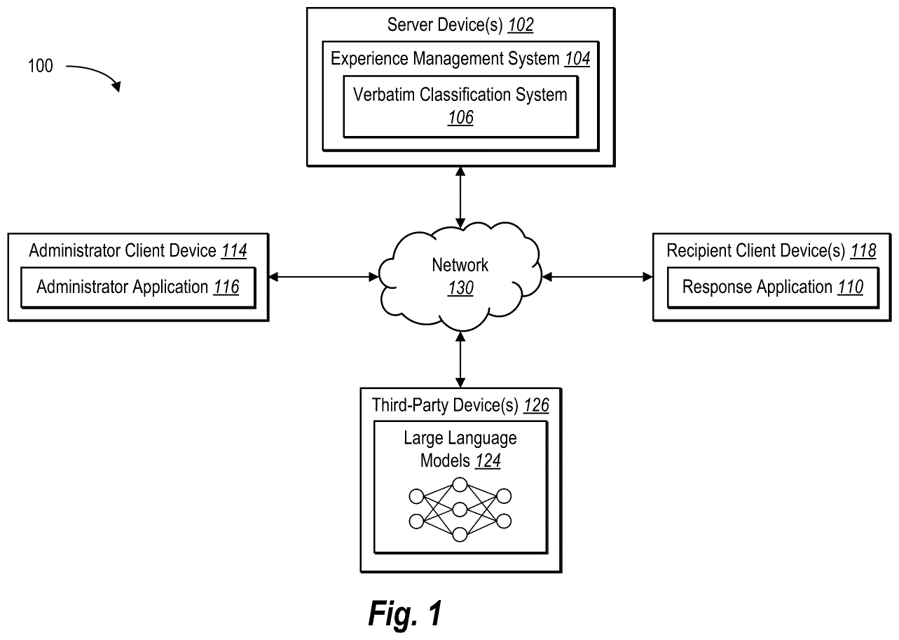

Turning now to the figures, FIG. 1 illustrates a block diagram of a system environment (“environment”) 100 in which an experience management system 104 and a verbatim classification system 106 operate in accordance with one or more embodiments. As illustrated in FIG. 1, the environment 100 includes server device(s) 102, an administrator client device 114, recipient client device(s) 118, network 130, and third-party device(s) 126, where the server device(s) 102 include the experience management system 104.

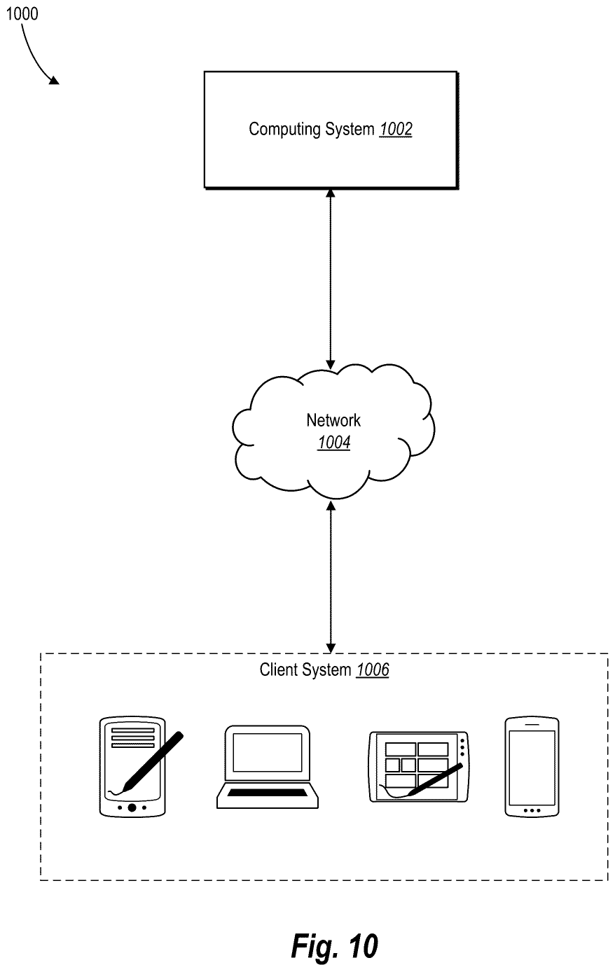

As shown in FIG. 1, the experience management system 104 comprises the verbatim classification system 106. The server device(s) 102, the administrator client device 114, the recipient client device(s) 118, and the third-party device(s) 126 are communicatively coupled with each other either directly or indirectly through the network 130 (as discussed in greater detail below in relation to FIG. 10). Additionally, in some embodiments, the server device(s) 102, the administrator client device 114, the recipient client device(s) 118, network 130, and the third-party device(s) 126 include a variety of computing devices (including one or more computing devices as discussed in greater detail with relation to FIG. 10).

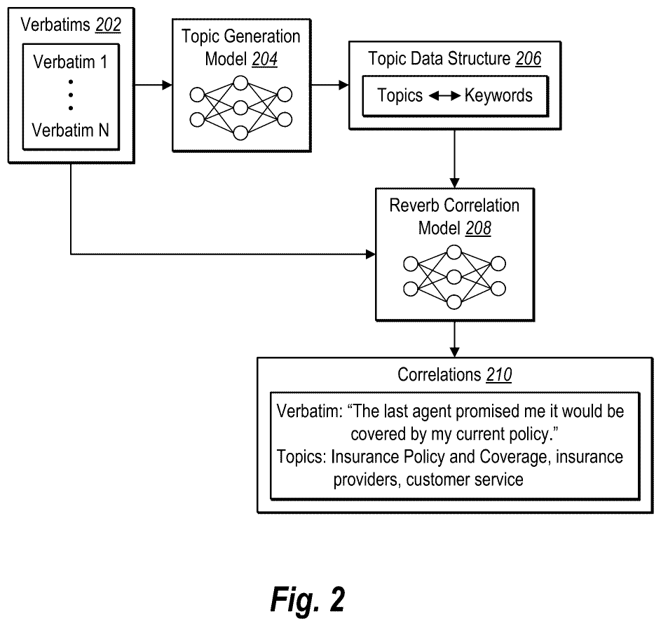

In some embodiments, the administrator client device 114 and the recipient client device(s) 118 communicate with server device(s) 102 over the network 130. As described below, the server device(s) 102 can enable the various functions, features, processes, methods, and systems described herein using, for example, the verbatim classification system 106. As shown in FIG. 1, the verbatim classification system 106 comprises computer executable instructions that, when executed by a processor of the server device(s) 102, perform certain actions described below with reference to FIGS. 2-10. Additionally, or alternatively, in some embodiments, the server device(s) 102 coordinate with one or both of the administrator client device 114 and the recipient client device(s) 118 to perform or provide the various functions, features, processes, methods, and systems described in more detail below. Although FIG. 1 illustrates a particular arrangement of the server device(s) 102, the administrator client device 114, the recipient client device(s) 118, the third-party device(s) 126, and the network 130, various additional arrangements are possible. For example, the server device(s) 102 and the experience management system 104 may directly communicate with the administrator client device 114, bypassing the network 130.

Generally, the administrator client device 114 and recipient client device(s) 118 may be any one of various types of client devices. For example, the administrator client device 114, the recipient client device(s) 118, and the third-party device(s) 126 may be mobile devices (e.g., a smart phone, tablet), laptops, desktops, or any other type of computing devices, such as those described below with reference to FIG. 10. Additionally, the server device(s) 102 may include one or more computing devices, including those explained below with reference to FIG. 10. The server device(s) 102, the administrator client device 114, the recipient client device(s) 118, and the third-party device(s) 126 may communicate using any communication platforms and technologies suitable for transporting data and/or communication signals, including the examples described below with reference to FIG. 10.

In some cases, the administrator application 116 and the response application 110 access the functionalities of the verbatim classification system 106. In some embodiments, one or both of the administrator application 116 and the response application 110 comprise web browsers, applets, or other software applications (e.g., native applications or web applications) available to the administrator client device 114 or the recipient client device(s) 118, respectively. Additionally, in some instances, the experience management system 104 provides data packets including instructions that, when executed by the administrator client device 114 or the recipient client device(s) 118, create or otherwise integrate the administrator application 116 or the response application 110 within an application or webpage for the administrator client device 114 or the recipient client device(s) 118, respectively.

As an initial overview, the server device(s) 102 provide the administrator client device 114 access to the experience management system 104 and the verbatim classification system 106 by way of the network 130. In one or more embodiments, by accessing the experience management system 104, the server device(s) 102 provide one or more digital documents to the administrator application 116 to enable the administrator client device 114 to assign topics to verbatims. For example, the experience management system 104 can include a website (e.g., one or more webpages) or utilize the administrator application 116 to enable the administrator client device 114 to generate topics, classifications, reports, or other digital content for distribution to the recipient client device(s) 118.

In addition, while FIG. 1 illustrates the use of the experience management system 104 on the server device(s) 102 to assign topics to verbatims, the communication environment can utilize other services or devices to assign topics to verbatims. For example, the experience management system 104 can access third-party device(s) 126 including large language models 124. In some cases, the experience management system 104 accesses the large language models 124 to generate topics from verbatims, determine correlations between verbatims and topics, provide explanations for verbatims/topics, or other features of the experience management system 104. Accordingly, various embodiments below are discussed with respect to accessing the experience management system 104 for explanation purposes, but it is understood the principles and features described herein are applicable for execution on additional devices.

In some cases, the administrator client device 114 launches the administrator application 116 to facilitate interacting with the experience management system 104 or the verbatim classification system 106. The administrator application 116 may coordinate communications between the administrator client device 114 and the server device(s) 102 that ultimately result in the creation of topics, classifications, reports, or other digital content that the experience management system 104 distributes to one or more of the recipient client device(s) 118. For instance, to facilitate creating/managing the correlations between topics and verbatims, the administrator application 116 provides graphical user interfaces of the experience management system 104, receive indications of interactions from the administrator application 116 with the administrator client device 114, and cause the administrator client device 114 to communicate user input based on the detected interactions to the experience management system 104, such as communicating a textual response.

As noted above, the verbatim classification system 106 can apply multiple models to extract topics from verbatims and to reconnect the verbatims to the topics by generating verbatim correlations. FIG. 2 provides a brief example of one such embodiment of the verbatim classification system 106. In particular, FIG. 2 illustrates the verbatim classification system 106 applying a topic generation model 204 and a reverb correlation model 208 to generate correlations 210 in accordance with one or more embodiments.

As shown in FIG. 2, the verbatim classification system 106 receives verbatims 202. As used herein, the term “verbatim” refers to unstructured textual content such as natural language user input. For example, the verbatims 202 includes unstructured textual content sourced from applications, emails, survey responses, conversations, reviews, and/or social posts. In some cases, the verbatims 202 maintain fidelity with the source application through a precise reproduction of the textual content including punctuation, wording, errors, and peculiarities. In some cases, the verbatims 202 include reproductions of the textual content that includes a close approximation of the textual content from the source allowing for minor inaccuracies or adjustments. As an example, the verbatim classification system 106 utilizes the verbatims 202 corresponding to user comments (including the words, tone, punctuation) associated with a product, service, or experience to generate topics based on the original textual content without undue alteration or interpretation.

After receiving the verbatims 202, the verbatim classification system 106 provides the verbatims 202 to the topic generation model 204. As used herein, the term “topic generation model” refers to a model that generates a topic data structure 206 from the verbatims 202 which includes topics and associated keywords. In some cases, the topic data structure 206 generates topics conveying underlying themes and keywords associated with the topics. In some cases, the topic data structure 206 includes topics associated with the group of verbatims but disconnected from individual instances of the verbatims 202. For example, in some embodiments, the topic generation model 204 does not pinpoint specific instances of the verbatims 202 (e.g., Verbatim 1, Verbatim 2) that directly relate to specific topics. Instead, the topic generation model 204 utilizes generalized patterns and themes within the verbatims 202 to determine the topics.

In some cases, the topic generation model 204 includes or refers to a machine learning model trained to perform computer tasks to generate textual content (e.g., topics, keywords, summaries, examples, descriptions, sentiments). A machine learning model includes a computer algorithm or a collection of computer algorithms that can be trained and/or tuned based on inputs to approximate unknown functions. A machine learning model includes a neural network (e.g., a deep neural network) that analyzes a language input to generate a predicted output. For example, a machine learning model includes a neural network that generates a topics and associated keywords, summaries, examples, descriptions, and/or sentiments based on an input query and the verbatims 202. In some cases, the machine learning models utilize a transformer architecture, which includes mechanisms such as self-attention, to capture contextual relationships in the data.

For example, a machine learning model can include a computer algorithm with branches, weights, or parameters that change based on training data to improve for a particular task. Thus, a machine learning model can utilize one or more learning techniques (e.g., supervised or unsupervised learning) to improve in accuracy and/or effectiveness. Example machine learning models include various types of decision trees (e.g., gradient boost models), support vector machines, Bayesian networks, random forest models, or neural networks (e.g., deep neural networks, generative adversarial neural networks, convolutional neural networks, recurrent neural networks, or diffusion neural networks). Similarly, as used herein, a neural network refers to a machine learning model of interconnected nodes (or neurons) organized into layers. A neural network can include parameters or weights between neurons that are adjusted during training to minimize the error (or measure of loss) in generating predictions.

Along these lines, the machine learning models used herein can be trained and/or fine-tuned based on a diverse text corpora to perform natural language processing tasks, such as generating topics, keywords, summaries, examples, descriptions, and sentiments. For example, the machine learning models, consist of layers of interconnected artificial neurons organized in encoder and decoder blocks, which learn complex language patterns to generate textual content. In some cases, the machine learning models include models such as Vicuna, GPT (Generative Pre-trained Transformer), BERT (Bidirectional Encoder Representations from Transformers), T5 (Text-To-Text Transfer Transformer), LLAMA, or similar architectures that utilize self-attention mechanisms in natural language understanding and generation. In particular, in certain embodiments, the topic generation model 204 refers to an artificial neural network that generates the topic data structure 206 from the verbatims 202.

Relatedly, the term “topic data structure” refers to a data structure that includes topics and associated content. For example, the topic generation model 204 generates the topic data structure 206 including topics mapped to associated keywords. In some cases, the topic generation model 204 generates the topic data structure 206 including topics mapped to associated keywords, summaries, examples, descriptions, headlines, and/or sentiments. In particular, the topic generation model 204 generates the topic data structure 206 including topics and associated content representing subjects or underlying themes from the verbatims 202.

Upon generating the topic data structure 206, the verbatim classification system 106 provides the topic data structure 206 to the reverb correlation model 208. As used herein, the term “reverb correlation model” refers to a model that generates correlations 210 between verbatims and the topic data structure 206. For example, the verbatim classification system 106 prompts a reverb correlation model 208 with a custom prompt to cause the reverb correlation model 208 to determine the correlations 210 between the topics of the topic data structure 206 (and associated content) and the verbatims 202. Based on the custom prompt, the reverb correlation model 208 determines the correlations 210 between the verbatims 202 and the topics. Furthermore, the reverb correlation model 208 assigns the topics to the verbatims 202 based the correlations 210 between the verbatims 202 and the topics (e.g. connecting the verbatims 202 to the topics).

In some cases, the verbatim classification system 106 prompts a reverb correlation model 208 with a custom prompt to cause the reverb correlation model 208 to determine the correlations 210 between the topics of the topic data structure 206 (and associated content) and new verbatims (e.g., additional verbatims separate from verbatims 202 and not used to generate the topic data structure 206). Based on the custom prompt, the reverb correlation model 208 determines the correlations 210 between the verbatims (e.g., the verbatims 202 and/or the new verbatims) and the topics. Moreover, the reverb correlation model 208 assigns the topics to the new verbatims based the correlations 210 between the new verbatims and the topics.

In some cases, the reverb correlation model 208 includes or refers to a machine learning model as described above. In some cases, the reverb correlation model 208 includes a zero-shot semantic similarity model designed to categorize text data into predefined categories without requiring any prior training on labeled examples of those categories. For example, instead of learning from examples, the zero-shot semantic similarity model leverages an understanding of language and context to make predictions (e.g., by evaluating a cosine similarity). In some cases, the reverb correlation model 208 includes a model such as a large language model, a cross encoder, a semantic similarity model, an encoder/decoder model, or a retriever model. In particular, in certain embodiments, the topic generation model 204 refers to a machine learning model that generates the correlations 210 between the verbatims 202 and the topic data structure 206.

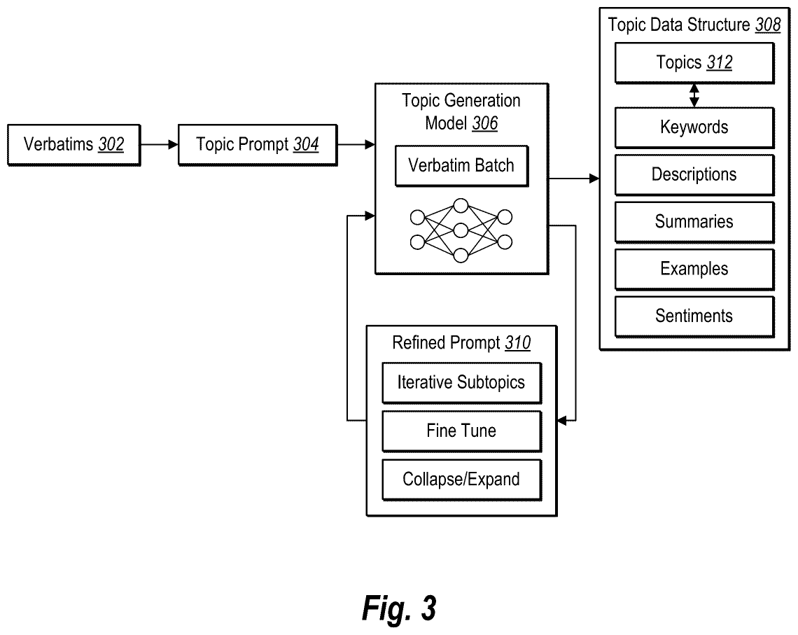

As suggested above, in some embodiments, the verbatim classification system 106 causes a topic generation model 306 to generate a topic data structure based on one or more custom prompts. FIG. 3 illustrates a topic generation model 306 generating a topic data structure 308 in accordance with one or more embodiments.

As represented in FIG. 3, the verbatim classification system 106 utilizes a topic prompt 304 to case the topic generation model 306 to generate the topic data structure 308. For example, the verbatim classification system 106 generates the topic prompt 304 as an input to the topic generation model 306 to instruct the topic generation model 306 to generate the topic data structure 308 from the verbatims 302. For example, based on the topic prompt 304, the topic generation model 306 generates topics 312 for the topic data structure 308 by determining underlying themes within the verbatims 302. In some cases, based on the topic prompt 304, the topic generation model 306 generates topics 312 by identifying semantic similarities and co-occurrences of underlying themes within the verbatims 302. As represented, based on the topic prompt 304, the topic generation model 306 generates the topic data structure 308 which includes topics 312 and associated keywords, summaries, examples, descriptions, and/or sentiments.

As an example, in some embodiments, the verbatim classification system 106 utilizes a topic prompt 304 such as the following:

Here is a list of customer comments, in <sentences></sentences> XML
tags:
<sentences>
{ }
</sentences>

Follow these steps:
1. Please extract at least 5 top topics being discussed in the customer comments.
2. For each topic provide at least 7 keywords that describe the topic.
3. For each topic provide a summary headline stating what the customers are saying about the topic.
4. For each topic, please extract 4 word-for-word quotes from the human input that provide best justification for the topic summary. Do not generate any new examples. Provide it within the <examples></examples> tag.
5. For each topic provide a list of 3 sentences describing the customer comments on the topic. Provide it within the <description></description> tag.
6. For each topic identify the sentiment. Sentiment categories are as follows: “Very Negative”, “Negative”, “Mixed”, “Neutral”, “Positive”, “Very Positive”.
7. After extracting all topics, please summarize the comments, we want a paragraph giving some valuable details at a high level to set context for the user. Provide it within the <summary></summary> tag.
8. After extracting all topics, please generate a one line headline for the summary. You can include up to 2 themes and majority sentiment of customer comments in this headline. Frame it as a short and informative single sentence. Provide it within the <title></title> tag.
9. Use the following output format:

Output Format:
Topic: name of topic
Keywords: keywords associated with topic
Summary: summary of topic
<examples>
1. customer comment 1
2. customer comment 2
3. customer comment 3
4. customer comment 4
</examples>
<description>
- customer description 1
- customer description 2
- customer description 3
</description>
Sentiment: sentiment of topic
<summary>Overall summary</summary>
<title>Overall title</title>
Assistant:

The topic generation model 306 generates the topic data structure 308 including keywords which incorporate specific words or phrases identifying the concepts related to each of the topics 312 based on the topic prompt 304. In some cases, the topic generation model 306 generates the topic data structure 308 including summaries which incorporate concise overviews of the topics and outlines of the main points. In some cases, the topic generation model 306 generates the topic data structure 308 including headlines which incorporate brief and attention-grabbing titles or phrases. In some cases, the topic generation model 306 generates the topic data structure 308 including examples which incorporate instances or sample verbatims that illustrate the topics in a practical context (e.g., how the topic is applied or manifested in real-world situations). In some cases, the topic generation model 306 generates the topic data structure 308 including descriptions which incorporate detailed explanations of the topics. In some cases, the topic generation model 306 generates the topic data structure 308 including sentiments which capture the emotional tone or opinion related to the topic (e.g., positive, negative, neutral, or mixed).

In some embodiments, the verbatim classification system 106 utilizes the topic generation model 306 to determine the topic data structure 308 for subsets of the verbatims 302. For example, the topic generation model 306 determines a first subset of topics from a first subset of the verbatims 302 and determines a second subset of topics from a second subset of the verbatims 302. The verbatim classification system 106 generates the topics 312 (and corresponding content of the topic data structure 308) by combining the first subset of topics and the second subset of topics and deduping duplicate topics.

In some embodiments, the verbatim classification system 106 fine-tunes the topics 312 and the topic data structure 308 utilizing a refined prompt 310. For example, the verbatim classification system 106 utilizes the topic generation model 306 to extract the topics 312 from the verbatims 302 (each topic associated with one or more keywords). In turn, the verbatim classification system 106 generates a refined prompt 310 to cause the topic generation model 306 to generate a subset of the topics 312 based on a relative semantic similarity of the topics 312 to the verbatims 302. In this way, the verbatim classification system 106 guides the topic generation model 306 to focus on specific aspects of the topics 312 that are more semantically relevant to the verbatims 302. To illustrate, in some cases, the topic generation model 306 generates a subset of the topics 312 with a semantic similarity greater than 0.60. As another example, in some cases, the topic generation model generates a subset of the topics 312 by selecting the top third of the topics 312 based on a relative semantic similarity.

In some embodiments, the verbatim classification system 106 iteratively refines the topic data structure 308 to expand or collapse the topics. For example, the verbatim classification system 106 utilizes the topic generation model 306 to extract topics from the verbatims 302 wherein the topics are identified as either too expansive (covering too broad a range of content) or too specific (narrowly focused on minor details) for the needs of the system or the. As a result, the verbatim classification system 106 generates a refined prompt 310 to cause the topic generation model 306 to iteratively refine the topic data structure 308 by providing the refined prompt 310 (and the topics) to the topic generation model 306. In some cases, the verbatim classification system 106 generates the refined prompt 310 to cause the topic generation model 306 to modify the topic data structure by expanding at least one of the topics 312 into subtopics. In some cases, the verbatim classification system 106 generates the refined prompt 310 to cause the topic generation model 306 to modify the topic data structure by collapsing the topics 312 by combining one or more of the topics 312.

To illustrate, the topic generation model 306 analyzes verbatims 302 from a source(s) such as customer reviews, surveys, and/or social media posts. The topic generation model 306 initially generates the topics 312 to include a topic “customer service” from the verbatims 302 based on analyzing the underlying themes within the verbatims 302. The verbatim classification system 106 identifies the topic “customer service” as too broad, encompassing additional underlying themes such as “response time,” “employee behavior,” and “problem resolution.” In turn, the verbatim classification system 106 generates the refined prompt 310 to cause the topic generation model 306 to expand the topic “customer service” into subtopics. As a result, the topic generation model 306 generates the topic data structure 308 by expanding the topics 312 to include the more specific subtopics of “response time” and “problem resolution” with associated keywords, summaries, descriptions, examples, and/or sentiments. Notably, in this example, the topic generation model 306 does not generate the subtopic of “employee behavior” (or expand other possible subtopics for customer service) due to an analysis of the underlying themes of the verbatims 302 (e.g., a lack of verbatims 302 associated with “employee behavior”).

In some embodiments, the verbatim classification system 106 utilizes the topic generation model 306 to update the topic data structure 308 based on receiving additional verbatims. For example, based on receiving additional verbatims (in addition to the verbatims 302), the verbatim classification system 106 provides the additional verbatims to the topic generation model 306 to update the topic data structure 308. In some cases, the verbatim classification system 106 updates the topic data structure 308 based on determining a change in the volume of verbatims (the additional verbatims and the verbatims 302) satisfies a change threshold by comparing the quantity of the additional verbatims to the quantity of the verbatims 302. In some cases, the verbatim classification system 106 updates the topic data structure 308 based on determining the quantity of additional verbatims satisfies a change threshold based on the quantity of the additional verbatims.

To illustrate, in some embodiments, the topic generation model 306 generates a topic data structure 308 such as the following:
Topic: Insurance
Sub-Topic: Medical insurance
Keywords: insurance, coverage, provider, deductible, benefits, eligibility, network
Summary: Customers are seeking information about their medical insurance coverage including eligibility, benefits, providers and deductibles.
Examples:
   ‘My boy I do not know models and your other line of the custom.’ ‘If you would just verify your email address.’
   ‘I am calling from Firm Name LLC in sense that the request of Dr. John Doe office to verify benefits and eligibility for Jane Doe.’
   ‘I just got a hold your initials next to me and my guardian and now the MMS.’
Description:
   Customers are asking questions about their insurance eligibility and coverage They want to verify benefits and check on deductibles and network providers People are seeking clarification on claims and costs related to medical procedures
Sentiment: Neutral

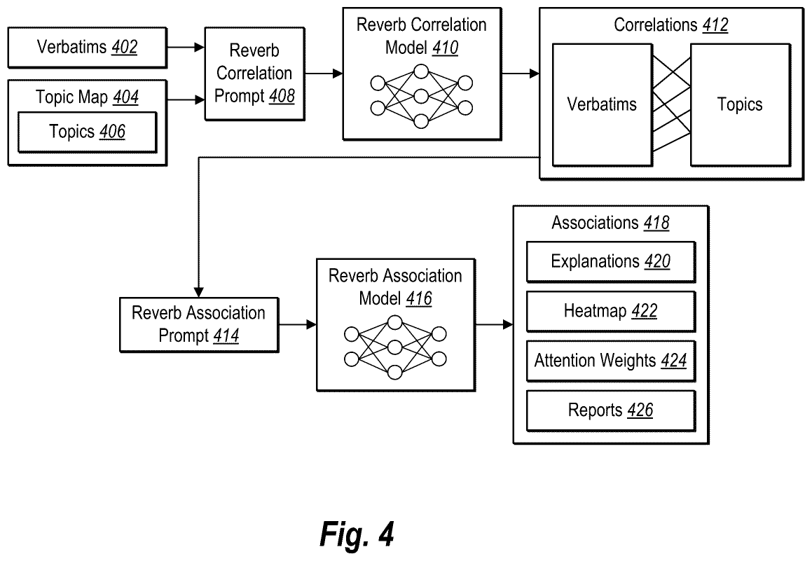

As mentioned, in some cases, the verbatim classification system 106 utilizes a reverb correlation model to generate correlations between the verbatims and the topics. For example, the verbatim classification system 106 utilizes a reverb association model 416 to generate associations 418 for the correlations 412 between the verbatims 402 and the topics 406. FIG. 4 illustrates the verbatim classification system 106 utilizing a reverb correlation model 410 to generate the correlations 412 in conjunction with a reverb association model 416 to generate the associations 418 in accordance with one or more embodiments.

As represented in FIG. 4, the verbatim classification system 106 utilizes a reverb correlation prompt 408. For example, the verbatim classification system 106 generates the reverb correlation prompt 408 as an input to the reverb correlation model 410 to cause the reverb correlation model 410 to generate the correlations 412 between the verbatims 402 and the topics 406 (e.g., the topic map 404). For example, based on the reverb correlation prompt 408, the reverb correlation model 410 assigns the topics 406 from the topic map 404 to the verbatims 402 by determining the correlations 412 between the topics 406 and the verbatims 402. For example, the reverb correlation model 410 determines the correlations 412 based on determining a threshold semantic similarity metric reflecting a semantic relevance of the topics 406 to the verbatims 402.

In some cases, the reverb correlation model 410 includes one or more large language models trained to recognize topics 406 within verbatims 402 based on semantic associations between the verbatims 402 and the topics 406. For example, the reverb correlation model 410 includes a model such as a zero-shot semantic similarity model, a large language model, a cross encoder, a semantic similarity model, an encoder/decoder model, and/or a retriever model. In some cases, the verbatim classification system 106 selects and trains the reverb correlation model 410 based on a target language to generate the correlations 412 between the verbatims 402 and the topic map 404 across the target language.

In some cases, the reverb correlation model 410 includes a zero-shot semantic similarity model designed to categorize text data into predefined categories without requiring any prior training on labeled examples of those categories. For example, instead of learning from examples, the verbatim classification system 106 utilizes a zero-shot semantic similarity model for the reverb correlation model 410 to leverage an understanding of language and context to make predictions (e.g., by evaluating a cosine similarity). By utilizing a zero-shot semantic similarity model, the verbatim classification system 106 determines the correlations 412 for the verbatims 402 even when the reverb correlation model 410 has not encountered similar examples before (e.g., adapting to new verbatims).

In some cases, the verbatim classification system 106 utilizes a large language model as the reverb correlation model 410. The large language model is designed to understand the context and nuances of the natural language text of the verbatims 402. For example, the reverb correlation model 410 utilizes a large language model trained on vast amounts of textual content to understand and generate human-like text. In some cases, the verbatim classification system 106 utilizes a large language model as the reverb correlation model 410 to generate detailed and contextually relevant topics (e.g., the topics 406) from complex textual content within the verbatims 402, thereby improving the accuracy and depth of the analysis.

In some cases, the verbatim classification system 106 utilizes a reverb correlation model 410 as a cross encoder model to generate precise similarity measurements. For example, the verbatim classification system 106 utilizes a cross encoder model to process pairs of sentences or text segments together to directly compute similarity scores or relevance between text pairs. In particular, the verbatim classification system 106 utilizes a cross encoder model to generate precise metrics for the correlations 412 by measuring the semantic similarity between the verbatims 402 and the topics 406.

In some cases, the verbatim classification system 106 utilizes a reverb correlation model 410 as a semantic similarity model to determine the correlations 412. For example, the verbatim classification system 106 utilizes a semantic similarity model to compute the similarity between two pieces of textual content based on semantic content. For example, the reverb correlation model 410 utilizes a semantic similarity model to match the verbatims 402 to the topics 406 (and the topic map 404) by identifying which of the verbatims 402 are semantically related to which of the topics 406. In some cases, the reverb correlation model 410 utilizes cosine similarity on embeddings to measure how close the verbatims 402 are to the topics 406 in meaning.

In some cases, the verbatim classification system 106 utilizes a reverb correlation model 410 as an encoder/decoder model to determine the correlations 412. For example, the verbatim classification system 106 utilizes an encoder/decoder model to generate summaries, translations, and analysis of topics 406. For example, the reverb correlation model 410 utilizes an encoder/decoder model in sequence-to-sequence tasks, transforming an input sequence (encoder) into a different output sequence (decoder). In some cases, the verbatim classification system 106 utilizes an encoder/decoder model to take the verbatims 402 as input and produce concise topic summaries or detailed topic explanations as output for the topics 406.

In some cases, the verbatim classification system 106 utilizes a reverb correlation model 410 as a retriever model to determine the correlations 412. For example, the verbatim classification system 106 utilizes a retrieval model in conjunction with embeddings to quickly find and rank relevant text segments from the verbatims 402. For example, the verbatim classification system 106 utilizes a retrieval model to identify the most relevant verbatims of the verbatims 402 for a given topic of the topics 406.

In some cases, the verbatim classification system 106 utilizes a combination of models to generate the correlations 412 and the associations 418 for the topics 406. For example, the verbatim classification system 106 utilizes a combination of the zero-shot semantic similarity model, the large language model, the cross encoder model, the semantic similarity model, the encoder/decoder model, and/or the retriever model as outlined above. In particular, in certain embodiments, the reverb correlation model 410 shown in FIG. 4 refers to a combination of one or more of the zero-shot semantic similarity model, the large language model, the cross encoder model, the semantic similarity model, the encoder/decoder model, and/or the retriever model.

As an example, in one or more embodiments, the verbatim classification system 106 utilizes the large language model to generate the topics 406 from the verbatims 402. In turn, the verbatim classification system 106 utilizes the cross encoder model to evaluate the semantic similarity between the topics 406 and the verbatims 402, optionally refining the topics 406 as described above. Furthermore, the verbatim classification system 106 utilizes the zero-shot semantic similarity model to categorize new verbatims into the topics 406 (e.g., the refined topics). In addition, the verbatim classification system 106 utilizes the encoder/decoder model to generate real-time updates to the topics 406 (and topic map 404) for new verbatims.

As shown in FIG. 4, in some embodiments, the verbatim classification system 106 utilizes a combination of the reverb correlation model 410 and the reverb association model 416. For example, the verbatim classification system 106 generates the reverb association prompt 414 as an input to the reverb association model 416 to instruct the reverb association model 416 to generate associations 418 from the correlations 412. For example, based on the reverb association prompt 414, the reverb association model 416 generates the associations 418 by evaluating the correlations 412 to determine the applicability of the correlations 412, determining a relative importance and weights for the correlations 412.

For example, the reverb association model 416 generates the associations 418 as a tool to enhance the understanding and interpretation of the correlations 412. In some cases, based on the reverb association prompt 414, the reverb association model 416 generates the associations 418 which include explanations 420, heatmap 422, attention weights 424, and reports 426. For example, the reverb association model 416 generates the explanations 420 which include detailed explanations for why the correlations 412 are determined as matches between the verbatims 402 and the topic map 404. In some cases, the reverb association model 416 generates the heatmap 422 which identifies which of the verbatims 402 are most strongly associated with specific topics to identify patterns and areas of focus. In some cases, the reverb association model 416 generates the attention weights to identify which of the correlations 412 are more significant and prioritize certain of the verbatims 402 or the topics 406. In some cases, the reverb association model 416 generates the reports 426 to compile the correlations 412 and provide insights into the correlations 412, including summaries, examples, and analysis.

To illustrate, in one or more embodiments, the verbatim classification system 106 analyzes customer feedback as depicted in FIG. 4. For example, the verbatim classification system 106 generates the reverb correlation prompt 408 to cause the reverb correlation model 410 to identify correlations 412 between customer comments (e.g., the verbatims 402) and common issues or praise (e.g., the topics 406). The verbatim classification system 106 utilizes the reverb association prompt 414 to cause the reverb association model 416 to evaluate the correlations 412, generating the associations 418.

For example, the reverb association model 416 determines that comments about “delivery time” have a strong correlation with negative sentiments (e.g., common issues). As a result, the verbatim classification system 106 assigns a high value within the attention weights 424 to the correlations 412 associated with “delivery time.” The verbatim classification system 106 also generates the heatmap 422 which provides a visual depiction of the strong negative correlation between verbatims 402 associated with “delivery time” and customer satisfaction. Moreover, the verbatim classification system 106 generates and displays the attention weights 424 to indicate that “delivery time” is a critical area for improvement. Furthermore, the verbatim classification system 106 provides the reports 426 to summarize the findings about the verbatims 402 associated with “delivery time” and/or suggests actions.

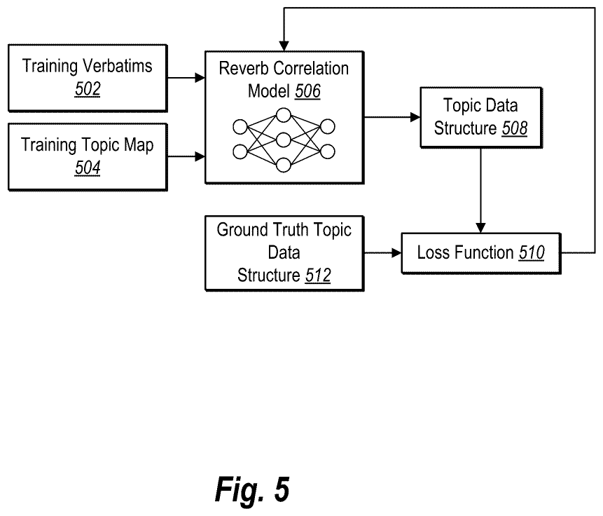

As suggested above, in some embodiments, the verbatim classification system 106 trains the reverb correlation model to correlate verbatims with topics. FIG. 5 illustrates the verbatim classification system 106 training a reverb correlation model to recognize connections between topics and verbatims in accordance with one or more embodiments.

As shown in FIG. 5, the verbatim classification system 106 trains the reverb correlation model 506 to generate the topic data structure 508. For example, the verbatim classification system 106 provides training verbatims 502 and a training topic map 504 to the reverb association model 416 to generate a topic data structure 508. Using multiple training iterations, the verbatim classification system 106 determines a loss from a loss function 510 based on a comparison of a topic data structure 508 to a ground truth topic data structure 512. The verbatim classification system 106 subsequently adjusts the weights and parameters of the reverb correlation model 506 based on the determined loss from the loss function 510. In turn, the verbatim classification system 106 performs subsequent training iterations for the training verbatims 502 and the training topic map 504.

To elaborate, in an initial training iteration, the verbatim classification system 106 inputs the training verbatims 502 and the training topic map 504 into the reverb correlation model 506. As part of such input, in some embodiments, the verbatim classification system 106 parses and tokenizes the training verbatims 502 and the training topic map 504. The verbatim classification system 106 subsequently inputs the tokens into the reverb correlation model 506. The reverb correlation model 506 generates the topic data structure 508 from the tokens from the training verbatims 502 and the training topic map 504. In some embodiments, for instance, the reverb correlation model 506 determines an encoded and context-aware representation for the textual content within the training verbatims 502 and the training topic map 504. Based on the encoded and context-aware representation for the textual content, the reverb correlation model 506 generates the topic data structure 508.

As further indicated in FIG. 5, the verbatim classification system 106 determines a loss from the loss function 510 based on a comparison of the topic data structure 508 and the ground truth topic data structure 512. In some embodiments, when training the reverb correlation model 506 the verbatim classification system 106 uses the ground truth topic data structure 512 as a reference point, to determine the loss with the loss function 510. In some embodiments, the verbatim classification system 106 uses a cross-entropy-loss function, an L2-loss function, a mean-absolute-error-loss function, a mean-squared-error-loss function, a root-mean-squared-error function, or other suitable loss function as the loss function 510 to compare the topic data structure 508 and the ground truth topic data structure 512 and to determine a loss.

Upon determining a loss from the loss function 510, the verbatim classification system 106 adjusts the network parameters (e.g., weights or values) of the reverb correlation model 506 to decrease the loss for the loss function 510 in a subsequent training iteration. For example, the verbatim classification system 106 may increase or decrease weights or values of the reverb correlation model 506 to minimize the loss in a subsequent training iteration.

As reflected by FIG. 5, after adjusting the network parameters of the reverb correlation model 506 for the initial training iteration, the verbatim classification system 106 performs additional training iterations until satisfying a convergence criteria. For instance, the verbatim classification system 106 iteratively provides training verbatims 502 to the reverb correlation model 506 to extract the topic data structure 508, iteratively determines losses from the loss function 510 based on comparisons of the topic data structure 508 and the ground truth topic data structure 512, and iteratively adjusts the parameters of the reverb correlation model 506 based on the determined losses. In some cases, the verbatim classification system 106 performs training iterations until the value or weights of the reverb correlation model 506 do not change significantly across training iterations based on a threshold change metric.

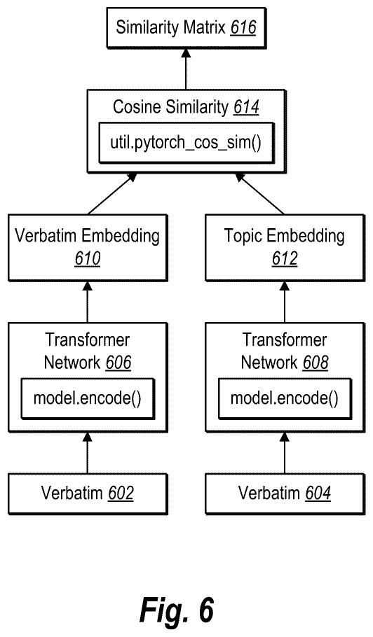

In some embodiments, the verbatim classification system 106 processes textual data, including verbatims and topics together. FIG. 6 illustrates utilizing a zero-shot semantic similarity classification model to recognize correlations between a verbatim 602 and a topic 604 in accordance with one or more embodiments.

As shown, the verbatim classification system 106 utilizes a zero-shot semantic similarity classification model to encode the verbatim 602 and the topic 604. For example, the verbatim classification system 106 encodes the verbatim 602 and the topic 604 into numerical representations. To elaborate, the verbatim classification system 106 splits the verbatim 602 into smaller parts (ensuring full words are retained by splitting at the nearest space character) to allow for a more granular analysis when comparing and assessing the relevance of the verbatim 602 to the topic 604. Similarly, the verbatim classification system 106 splits the topic 604 into smaller parts (ensuring full words are retained by splitting at the nearest space character).

Once the verbatim 602 and the topic 604 are encoded, the verbatim classification system 106 generates embeddings for the verbatim 602 and the topic 604. As shown, the verbatim classification system 106 utilizes a transformer network 606 and the model.encode( ) function for the verbatim 602 to generate the verbatim embedding 610. As also shown, the verbatim classification system 106 utilizes a transformer network 608 and the model.encode( ) function for the topic 604 to generate the topic embedding 612. In particular, the verbatim classification system 106 utilizes the model.encode( ) function separately for the verbatim 602 and the topic 604 to generate the verbatim embedding 610 and the topic embedding 612.). In one or more embodiments, the verbatim classification system 106 utilizes transformers pretrained on a similarity task (e.g., BERT, MPNet).

As shown, the verbatim classification system 106 computes the cosine similarity 614 between the encoded representations of the verbatim embedding 610 and the topic embedding 612. In some cases, the verbatim classification system 106 utilizes the util.pytorch_cos_sim( ) function to calculate the pairwise cosine similarities between the verbatim embedding 610 and the topic embedding 612 to generate the cosine similarity 614.

In turn, the verbatim classification system 106 generates a similarity matrix 616. The similarity matrix represents verbatims (e.g., one or more of the verbatim 602) in rows and topics in columns (e.g., on or more of the topic 604). The verbatim classification system 106 utilizes the similarity scores (e.g., the cosine similarity 614) in the similarity matrix 616 to indicate how closely each of the verbatim 602 is related to each of the topic 604. For example, a high similarity score indicates a strong relevance between a verbatim 602 and a topic 604.

In some embodiments, the verbatim classification system 106 subsequently performs the analysis represented by FIG. 6 in the reverse. In particular, to expand the correlation possibilities, the verbatim classification system 106 reverses the analysis (e.g., inputs) so that each topic 604 points to a verbatim 602 (instead of vice versa). By reversing the analysis, the verbatim classification system 106 increases the correlation space with a wider range of potential matches (by including topic names in the analysis) and enhances the relevance of the generated correlations. In this way, the verbatim classification system 106 provides a more accurate correlation between the verbatim 602 and the topic 604 without extensive labeled datasets in a highly adaptable analysis to generate correlations in various contexts.

After computing the similarity matrix 616, from a group of topics and verbatims, the verbatim classification system 106 selects the topics that are most relevant to the verbatim based on a predefined similarity threshold. In some embodiments, the verbatim classification system 106 utilizes a similarity threshold of 0.8 for similarity values between 0.0 and 1.0, where 1.0 indicates perfect similarity and 0.0 indicates no similarity. Furthermore, if no correlations between the topics and the verbatim meet the similarity threshold, the system assigns a default topic, such as “Other,” to ensure that every verbatim is categorized.

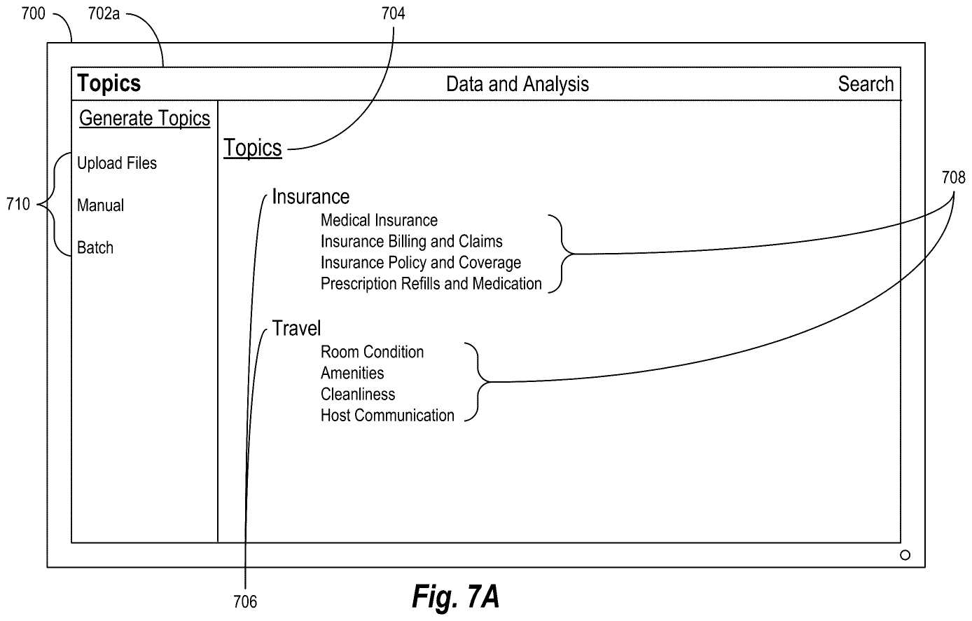

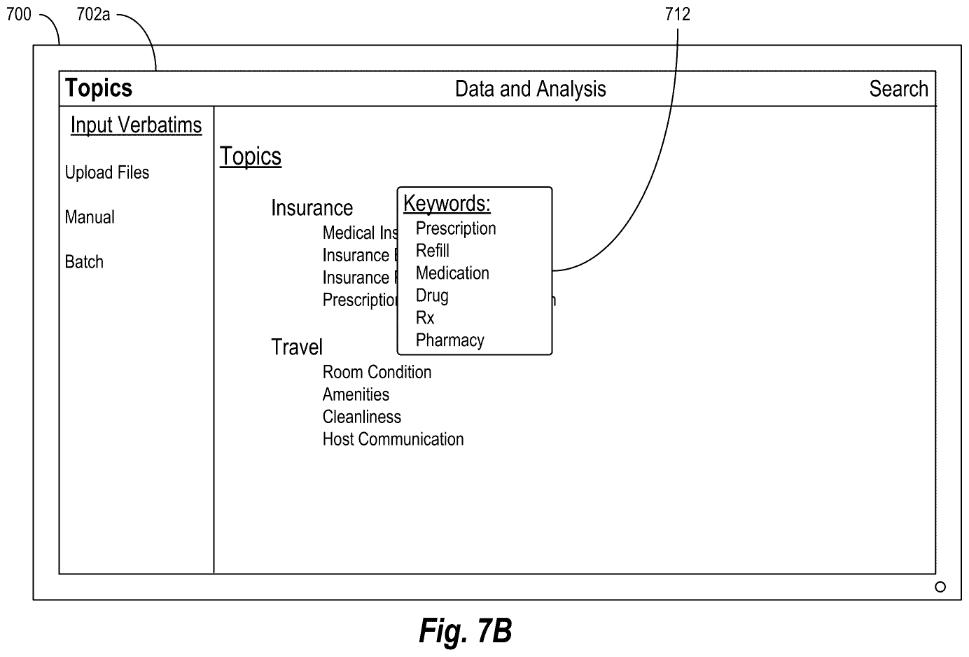

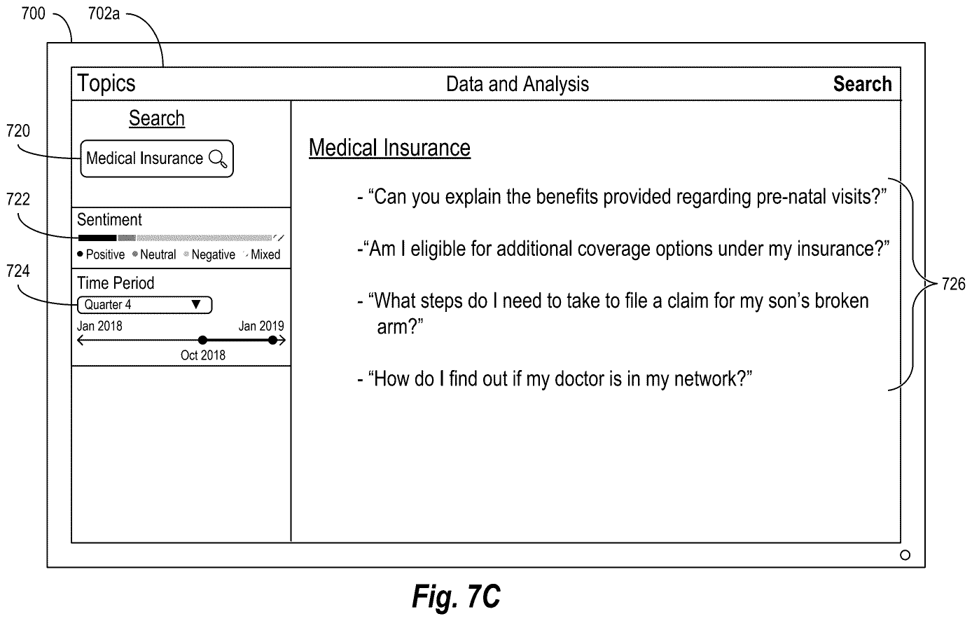

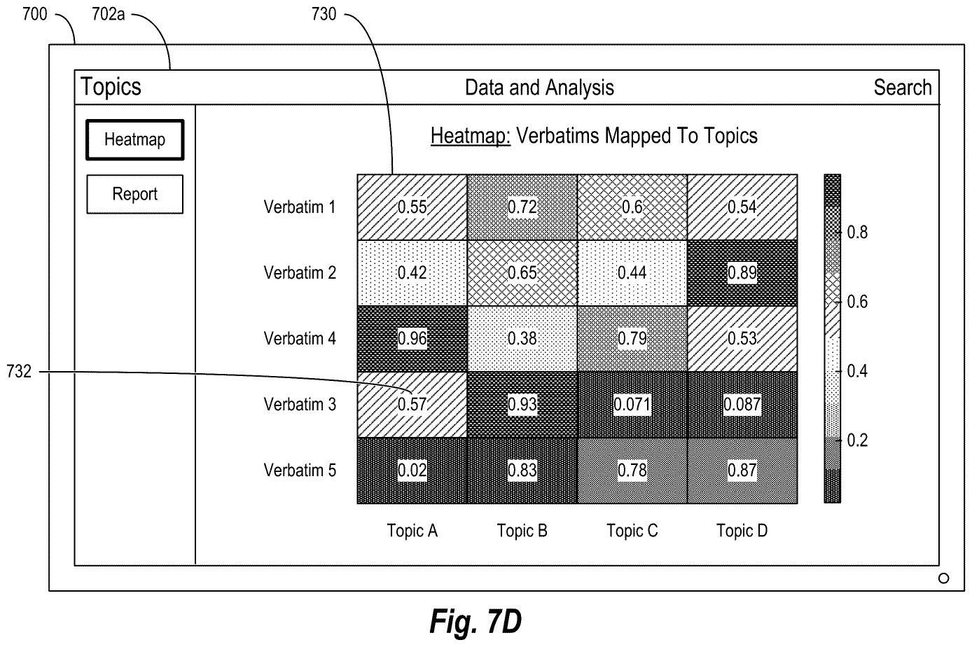

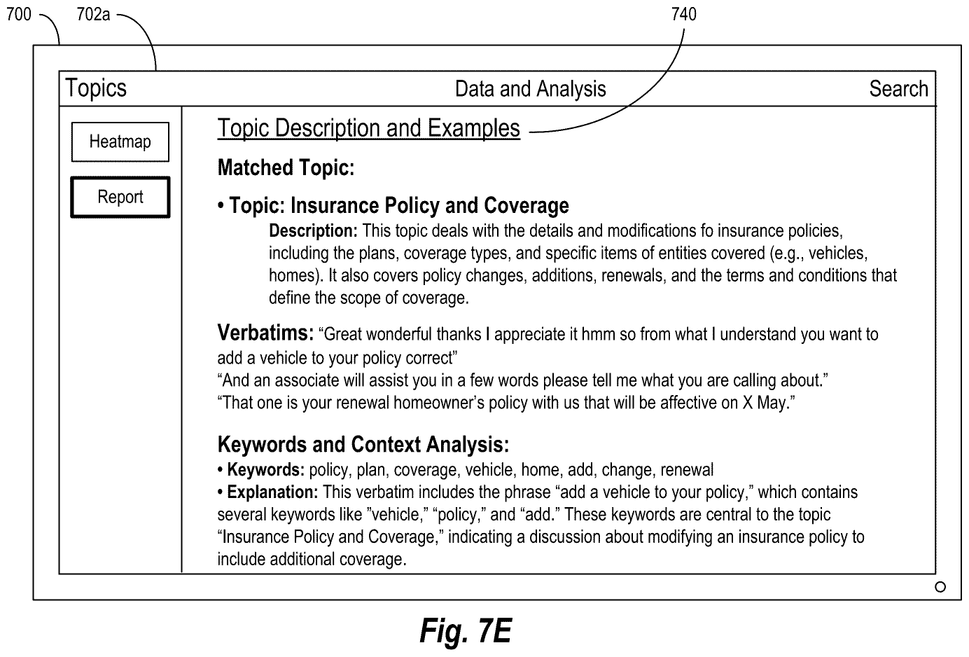

As discussed above, in some embodiments, the verbatim classification system 106 generates topics generated from input verbatims within a graphical user interface. FIGS. 7A-7E illustrate utilizing a computing device to display generated topics within a graphical user interface in accordance with one or more embodiments.

In these or other embodiments, the computing device 700 includes the server device(s) 102, the administrator client device 114, the recipient client device(s) 118, and/or third-party device(s) 126 executing the application (e.g., one or more of the administrator application 116, response application 110, or large language models 124). In some embodiments, the application comprises computer-executable instructions that (upon execution) cause the computing device 700 to perform certain actions depicted in the figure, such as presenting a graphical user interface of the application. Rather than refer to the application or the verbatim classification system 106 as performing the actions depicted in the figures below, this disclosure will generally refer to the computing device 700 performing such actions for simplicity.

As shown in FIG. 7A, the computing device 700 presents the user interface 702a displaying topics 704. The topics 706 and subtopics 708 include topics generated from verbatims as described above in relation to the foregoing figures. For example, the verbatim classification system 106 generates the topics 704 as described in relation to FIG. 3. As mentioned, the verbatim classification system 106 generates the topics 704 which convey underlying themes of verbatims. As also mentioned, the verbatim classification system 106 generates a topic data structure that includes the topics 704 as well as associated content (e.g., keywords, summaries, descriptions, examples, sentiments, and other content) from the verbatims.

In some cases, the verbatim classification system 106 generates or refines the topics 704 based on a selection of a generation option 710. To illustrate, the verbatim classification system 106 generates topics utilizing verbatims uploaded in files, input manually, added in batches, and/or utilizing other input methods. In some cases, the verbatim classification system 106 system iteratively refines the topics 704 to expand the topics 706 into the subtopics 708. In some cases, the verbatim classification system 106 iteratively refines the topics 704 by combining concepts (e.g., more specific subtopics) to generate the topics 704. In some cases, the verbatim classification system 106 incorporates predefined topics into the topics 704 based on a selection within the user interface 702a.

In particular, the verbatim classification system 106 provides the topics 704 including topics 706 as well as the associated subtopics 708 for display on the computing device 700. As shown, the topics 706 include the topic of “Insurance” and the associated subtopics 708 of “Medical insurance,” “Insurance billing and claims,” “Insurance policy and coverage,” and “prescription refills and medication.” The topics 706 also include the topic of “Travel” and the associated subtopics 708 of “Room condition,” “Amenities,” “Cleanliness,” and “Host communication.”

As further shown in FIG. 7B, the verbatim classification system 106 can display additional correlation information for the topics within the user interface 702a. For example, based on a user interaction with the user interface 702a, the verbatim classification system 106 can display the popup 712 including keywords associated with one or more of the topics 704. As described in relation to previous figures, the verbatim classification system 106 can generate and display the topic data structure including keywords, summaries, descriptions, examples, sentiments, and other content associated with the topics 704.

As mentioned, the verbatim classification system 106 can provide data and analysis based on the correlations between verbatims and topics. FIG. 7C illustrates utilizing a verbatim classification system to display correlations between verbatims and topics in accordance with one or more embodiments.

As shown in FIG. 7C, the verbatim classification system 106 provides a topic 720 and the verbatims 726 for display. As mentioned, the verbatim classification system 106 determines topics and assigns topics to verbatims based on determining correlations between the verbatims and the topics. Furthermore, based on a selection of the topic 720 and for display on the computing device 700, the verbatim classification system 106 provides the verbatims 726 based on determining a semantic relevance of the selected topic 720 to the verbatims 726. For example, the verbatim classification system 106 displays the verbatims 726 that satisfy a threshold semantic similarity metric and/or meet a correlation threshold semantic similarity with the selected topic 720.

As further shown, the verbatim classification system 106 includes additional ways to select correlated topics and verbatims for display. For example, the verbatim classification system 106 includes a sentiment selection element 722 to further refine the display of the verbatims correlated with the selected topic 720. In some embodiments, the verbatim classification system 106 selects the verbatims 726 that correspond to the sentiment selected by the sentiment selection element 722. Such response groups may include textual responses corresponding to a range of sentiment scores or to a particular sentiment label (e.g., positive sentiment, neutral sentiment, negative sentiment, mixed sentiment).

In some embodiments, the verbatim classification system 106 selects verbatims to display based on a selected time period element 724. For example, the verbatim classification system 106 displays the verbatims 726 that are correlated with the selected topic 720 and further correspond to the time period selected by the time period element 724. Similarly, in some embodiments, the verbatim classification system 106 provides a selectable option to display the verbatims 726 that satisfy a specified semantic similarity to the selected topic 720.

As mentioned, the verbatim classification system 106 can generate visual representations highlighting the strength and importance of the correlations between the verbatims and the topics. FIG. 7D illustrates utilizing a verbatim classification system 106 to display a heatmap representing correlations between a verbatim and a topic in accordance in accordance with one or more embodiments.

As shown, the verbatim classification system 106 displays a heatmap of verbatims mapped to topics. For example, the verbatim classification system 106 determines cosine similarities between encoded verbatims and topics to obtain a similarity metric. In some cases, the verbatim classification system 106 displays the similarity matrix as a heatmap, where the rows of the heatmap correspond to the verbatims and the columns correspond to the topics. In some cases, the verbatim classification system 106 utilizes a cell color intensity or cell crosshatching to indicate the magnitude of the similarity between the verbatims and the topics. For example, the verbatim classification system 106 utilizes a darker color to visually represent a higher similarity metric and a lighter color to represent a lower similarity metric for the corresponding verbatim/topic correlation.

As also shown in FIG. 7D, the verbatim classification system 106 displays attention weights for the correlations between the verbatims and the topics. For example, the verbatim classification system 106 displays a granular analysis of the similarity scores within the heatmap 730 utilizing attention weights. To illustrate, the verbatim classification system 106 displays the attention weight 732 of 0.57 for the correlation between Verbatim 3 and Topic A. In particular, the attention weight 732 represents a similarity value greater than half (e.g., more similar than not), where 1.0 indicates perfect similarity and 0.0 indicates no similarity.

To illustrate, utilizing the heatmap 730, the verbatim classification system 106 provides a visual tool within the interface 702a for the rapid identification of strong correlations between verbatims and topics. In this way, the verbatim classification system 106 provides a visual indication of patterns and areas of interest among the verbatims. Through this visual representation of the strengths between various correlations, the verbatim classification system 106 provides a visual indication of the relevancy of various topics and a visual aid to interpret the correlations. To illustrate, based on the heatmap 730, the verbatim classification system 106 provides a visual indication that Topic A is most relevant to Verbatim 4 (with an attention weight of 0.96 and a dark color cell), whereas Topic B is least relevant to Verbatim 4 (with an attention weight of 0.38 and a lighter color cell).

In some cases, the verbatim classification system 106 provides explanatory reports for display on client devices. FIG. 7E illustrates utilizing a verbatim classification system 106 to display an explanatory report for correlations between a verbatim and a topic in accordance with one or more embodiments.

As mentioned, the verbatim classification system 106 generates explanatory reports for the correlations between verbatims and topics. For example, as shown in FIG. 7E, the verbatim classification system 106 provides a Topic Description and Examples Report 740. As shown, utilizing the Topic Description and Examples Report 740, the verbatim classification system 106 provides concrete examples of verbatims that are strongly correlated with a topic as well as reasons that certain verbatims are classified under a topic. For example, the Topic Description and Examples Report 740 includes a detailed explanations of the topic, as well as associated verbatims, description, keywords, explanation, and/or associated textual content.

In one or more embodiments, the verbatim classification system 106 provides additional explanatory reports offering a deeper understanding of the classification process. For example, the verbatim classification system 106 provides an Overview Report including a high-level summary of the analysis of correlations between verbatims and topics, including the overall accuracy of the topic classifications. In this way, the verbatim classification system 106 can provide a correlated report identifying common issues or categorizing verbatims. As another example, the verbatim classification system 106 provides a Sentiment Analysis Report including an analysis of the sentiment associated with each topic, indicating whether the associated verbatims express positive, negative, neutral, or mixed sentiments. Relatedly, the verbatim classification system 106 provides graphs or charts showing how sentiments vary across different topics or over time. As another example, the verbatim classification system 106 provides a Recommendation Report including practical recommendations suggesting specific actions or strategies to address the identified issues or leverage positive feedback. In some cases, the verbatim classification system 106 provides suggested next steps for further analysis or follow-up actions to improve the overall understanding and/or response to the correlations.

Utilizing explanatory reports, the verbatim classification system 106 provides a comprehensive explanation of the correlation between verbatims and topics. In particular, the verbatim classification system 106 enhances the transparency and understanding of the underlying reasons for the correlations between the topics and the verbatims. By providing a variety of reports, the verbatim classification system 106 provides a way to accurately utilize the correlations and enables data-driven decisions.

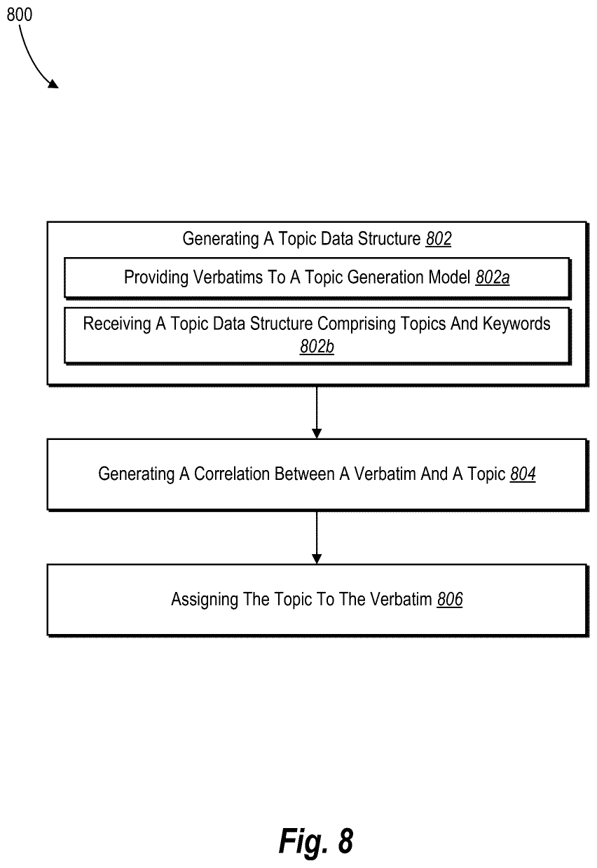

Turning now to FIG. 8, this figure illustrates a flowchart of a series of acts 800 for assigning a topic to a verbatim based on determining the correlation between the verbatim and the topic in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer readable storage medium can comprise instructions that, when executed by one or more processors, cause a computing device to perform the acts depicted in FIG. 8. In still further embodiments, a system can perform the acts of FIG. 8.

As shown in FIG. 8, the acts 800 include an act 802 of generating a topic data structure. In particular, in some embodiments, the act 802 includes the sub-act 802a of providing verbatims to a topic generation model and the sub-act 802b of receiving a topic data structure comprising topics and keywords. For instance, in certain implementations, the act 802 includes generating the topic data structure by providing a plurality of verbatims to the topic generation model, each verbatim comprising natural language user input text and receiving, as output from the topic generation model, the topic data structure comprising topics and keywords, wherein the topic data structure is disconnected from the plurality of verbatims.

As further shown in FIG. 8, the acts 800 include an act 804 of generating a correlation between a verbatim and a topic. In particular, in some embodiments, the act 804 includes generating, utilizing a reverb correlation model, a correlation between a verbatim and a topic of the topic data structure. As further shown in FIG. 8, the acts 800 include an act 806 of assigning the topic to the verbatim. In particular, in some embodiments, the act 806 includes assigning the topic to the verbatim based on the correlation between the verbatim and the topic to connect the verbatim to the topic.

In addition to the acts 802-806, the acts 800 may include additions or variations. In certain implementations, for instance, the acts 800 includes utilizing a topic generation model wherein the topic generation model is a large language model trained to generate a plurality of topics based on a plurality of verbatims, the plurality of topics conveying underlying themes and a plurality of keywords associated with the plurality of topics. In some cases, the acts 800 further includes utilizing a reverb correlation model wherein the reverb correlation model is a large language model trained to recognize topics within verbatims based on semantic associations between the verbatims and the topics.

Further, in one or more embodiments, the series of acts 800 includes receiving additional verbatims comprising additional natural language user input text. In addition, in one or more embodiments, the series of acts 800 includes updating the topic data structure by providing the additional verbatims to the topic generation model. Furthermore, in one or more embodiments, the series of acts 800 includes determining, based on receiving the additional verbatims, a change in a volume of verbatims satisfies a change threshold by comparing a quantity of the additional verbatims to a quantity of the plurality of verbatims. Additionally, in one or more embodiments, the series of acts 800 includes updating the topic data structure based on satisfying the change threshold.

Moreover, in one or more embodiments, the series of acts 800 includes extracting a plurality of topics from the plurality of verbatims, each topic of the plurality of topics associated with one or more keywords. Further, in one or more embodiments, the series of acts 800 includes generating the topics by selecting a subset of the plurality of topics based on a relative semantic similarity of the plurality of topics to the plurality of verbatims. Furthermore, in one or more embodiments, the series of acts 800 includes generating the topic data structure by determining a first subset of topics from a first subset of the plurality of verbatims. Moreover, in one or more embodiments, the series of acts 800 includes generating the topic data structure by determining a second subset of topics from a second subset of the plurality of verbatims. Additionally, in one or more embodiments, the series of acts 800 includes generating the topic data structure by generating the topics by combining the first subset of topics and the second subset of topics.

Moreover, in one or more embodiments, the series of acts 800 includes generating a heatmap representing correlations between the verbatim and the topic. In addition, in one or more embodiments, the series of acts 800 includes providing the heatmap for display on a client device. Additionally, in one or more embodiments, the series of acts 800 includes generating, utilizing a reverb association model, an explanatory report comprising one or more reasons the topic is assigned to the verbatim. Furthermore, in one or more embodiments, the series of acts 800 includes providing the explanatory report for display on a client device.

Moreover, in one or more embodiments, the series of acts 800 includes iteratively refining the topic data structure by providing the topics to the topic generation model, wherein iteratively refining the topic data structure modifies the topic data structure by expanding at least one topic into one or more subtopics. In addition, in one or more embodiments, the series of acts 800 includes assigning the topic to the verbatim by determining the correlation between the verbatim and the topic satisfies a threshold semantic similarity metric associated with a semantic relevance of the topic to the verbatim.

Furthermore, in one or more embodiments, the series of acts 800 includes utilizing a reverb correlation model wherein the reverb correlation model is a zero-shot semantic similarity model. Moreover, in one or more embodiments, the series of acts 800 includes determining, utilizing the reverb correlation model, the correlation between the verbatim and the topic by evaluating a cosine similarity between the verbatim and the topic. Additionally, in one or more embodiments, the series of acts 800 includes determining, based on receiving additional verbatims, a quantity of additional verbatims satisfies a change threshold based on the quantity of the additional verbatims. Further, in one or more embodiments, the series of acts 800 includes updating the topic data structure based on satisfying the change threshold.

Moreover, in one or more embodiments, the series of acts 800 includes determining a first subset of topics from a first subset of the plurality of verbatims. Additionally, in one or more embodiments, the series of acts 800 includes determining a second subset of topics from a second subset of the plurality of verbatims. Further, in one or more embodiments, the series of acts 800 includes generating the topics by combining the first subset of topics and the second subset of topics and deduping duplicate topics.

Moreover, in one or more embodiments, the series of acts 800 includes utilizing a topic generation model wherein the topic generation model is a large language model trained to generate a plurality of topics conveying underlying themes and a plurality of keywords associated with the plurality of topics. In addition, in one or more embodiments, the series of acts 800 includes utilizing a reverb correlation model wherein the reverb correlation model is a large language model trained to recognize topics within verbatims based on semantic associations between the verbatims and the topics.

Moreover, in one or more embodiments, the series of acts 800 includes selecting and training the reverb correlation model based on a target language. In addition, in one or more embodiments, the series of acts 800 includes assigning the topic to the verbatim based on determining the correlation between the verbatim and the topic satisfies a threshold semantic similarity metric based on a semantic relevance of the topic to the verbatim. Additionally, in one or more embodiments, the series of acts 800 includes selecting the verbatim from the plurality of verbatims provided to the topic generation model.

Embodiments of the present disclosure may comprise or utilize a special-purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In one or more embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural marketing features and/or methodological acts, it is to be understood that the subject matter defined in the appended claims is not necessarily limited to the described marketing features or acts described above. Rather, the described marketing features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a subscription model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing subscription model can be composed of various characteristics such as, for example, on-demand self-service, broad network access, resource pooling, rapid elasticity, measured service, and so forth. A cloud-computing subscription model can also expose various service subscription models, such as, for example, Software as a Service (“SaaS”), a web service, Platform as a Service (“PaaS”), and Infrastructure as a Service (“IaaS”). A cloud-computing subscription model can also be deployed using different deployment subscription models such as private cloud, community cloud, public cloud, hybrid cloud, and so forth. In this description and in the claims, a “cloud-computing environment” is an environment in which cloud computing is employed.

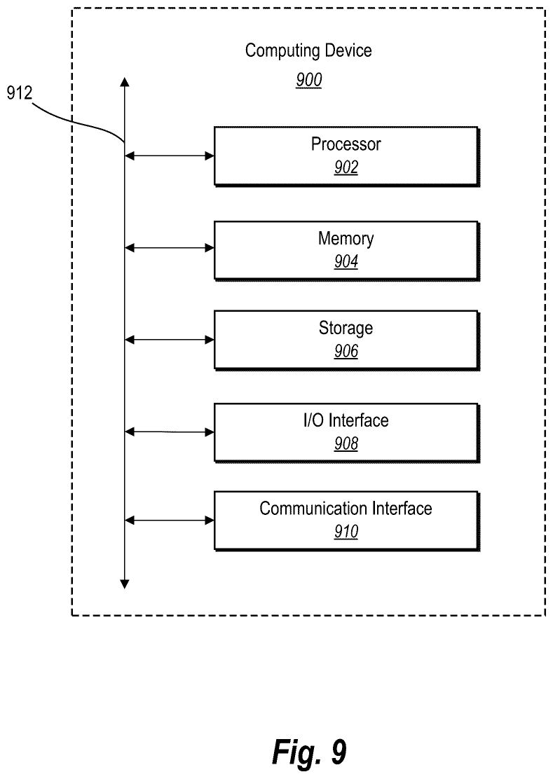

FIG. 9 illustrates a block diagram of an exemplary computing device 900 that may be configured to perform one or more of the processes described above. One will appreciate that one or more computing devices such as the computing device 900 may implement the server device(s) 102, the administrator client device 114, the recipient client device(s) 118, the third-party device(s) 126, and/or other devices described above in connection with FIG. 1. As shown by FIG. 9, the computing device 900 can comprise a processor 902, a memory 904, a storage device 906, an I/O interface 908, and a communication interface 910, which may be communicatively coupled by way of a communication infrastructure 912. While the exemplary computing device 900 is shown in FIG. 9, the components illustrated in FIG. 9 are not intended to be limiting. Additional or alternative components may be used in other embodiments. Furthermore, in certain embodiments, the computing device 900 can include fewer components than those shown in FIG. 9. Components of the computing device 900 shown in FIG. 9 will now be described in additional detail.

In one or more embodiments, the processor 902 includes hardware for executing instructions, such as those making up a computer program. As an example, and not by way of limitation, to execute instructions, the processor 902 may retrieve (or fetch) the instructions from an internal register, an internal cache, the memory 904, or the storage device 906 and decode and execute them. In one or more embodiments, the processor 902 may include one or more internal caches for data, instructions, or addresses. As an example, and not by way of limitation, the processor 902 may include one or more instruction caches, one or more data caches, and one or more translation lookaside buffers (“TLBs”). Instructions in the instruction caches may be copies of instructions in the memory 904 or the storage device 906.

The memory 904 may be used for storing data, metadata, and programs for execution by the processor(s). The memory 904 may include one or more of volatile and non-volatile memories, such as Random-Access Memory (“RAM”), Read Only Memory (“ROM”), a solid-state disk (“SSD”), Flash, Phase Change Memory (“PCM”), or other types of data storage. The memory 904 may be internal or distributed memory.

The storage device 906 includes storage for storing data or instructions. As an example, and not by way of limitation, storage device 906 can comprise a non-transitory storage medium described above. The storage device 906 may include a hard disk drive (“HDD”), a floppy disk drive, flash memory, an optical disc, a magneto-optical disc, magnetic tape, or a Universal Serial Bus (“USB”) drive or a combination of two or more of these. The storage device 906 may include removable or non-removable (or fixed) media, where appropriate. The storage device 906 may be internal or external to the computing device 900. In one or more embodiments, the storage device 906 is non-volatile, solid-state memory. In other embodiments, the storage device 906 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 908 allows a user to provide input to, receive output from, and otherwise transfer data to and receive data from the computing device 900. The I/O interface 908 may include a mouse, a keypad or a keyboard, a touch screen, a camera, an optical scanner, network interface, modem, other known I/O devices or a combination of such I/O interfaces. The I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 908 is configured to provide graphical data to a display for presentation to a user. The graphical data may be representative of one or more graphical user interfaces and/or any other graphical content as may serve a particular implementation.

The communication interface 910 can include hardware, software, or both. In any event, the communication interface 910 can provide one or more interfaces for communication (such as, for example, packet-based communication) between the computing device 900 and one or more other computing devices or networks. As an example, and not by way of limitation, the communication interface 910 may include a network interface controller (“NIC”) or network adapter for communicating with an Ethernet or other wire-based network or a wireless NIC (“WNIC”) or wireless adapter for communicating with a wireless network, such as a WI-FI.

Additionally, or alternatively, the communication interface 910 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 910 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 912 may include hardware, software, or both that couples components of the computing device 900 to each other. As an example and not by way of limitation, the communication infrastructure 912 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

FIG. 10 illustrates an example network environment 1000 of the experience management system 104. Network environment 1000 includes the computing system 1002 and the client system 1006 connected to each other by a network 1004. Although FIG. 10 illustrates a particular arrangement of client system 1006, computing system 1002, and network 1004, this disclosure contemplates any suitable arrangement of client system 1006, computing system 1002, and network 1004. As an example, and not by way of limitation, two or more devices of the client system 1006 and the computing system 1002 may be connected to each other directly, bypassing the network 1004. As another example, two or more devices of the client system 1006 and the computing system 1002 may be physically or logically co-located with each other in whole, or in part. Moreover, although FIG. 10 illustrates a particular number of the client system 1006 devices, computing system 1002 devices, and network 1004, this disclosure contemplates any suitable number of the client system 1006 devices, computing system 1002 devices, and network 1004. As an example, and not by way of limitation, network environment 1000 may include multiple of the client system 1006 devices, computing system 1002 devices, and network 1004.

This disclosure contemplates any suitable network for the network 1004. As an example and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more of the network 1004.

Links may connect the client system 1006, and the computing system 1002 to the network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”)), wireless (such as for example Wi-Fi or Worldwide Interoperability for Microwave Access (“WiMAX”)), or optical (such as for example Synchronous Optical Network (SONET) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client system 1006 may be an electronic device including hardware, software, or embedded logic components or a combination of two or more such components and capable of carrying out the appropriate functionalities implemented or supported by the client system 1006. As an example, and not by way of limitation, the client system 1006 may include any of the computing devices discussed above in relation to FIG. 9. The client system 1006 may enable a network user at the client system 1006 to access the network 1004.

In particular embodiments, the client system 1006 may include a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client system 1006 may enter a Uniform Resource Locator (“URL”) or other address directing the web browser to a particular server (such as server, or a server associated with a third-party system), and the web browser may generate a Hyper Text Transfer Protocol (“HTTP”) request and communicate the HTTP request to server. The server may accept the HTTP request and communicate to the client system 1006 one or more Hyper Text Markup Language (“HTML”) files responsive to the HTTP request. The client system 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, the computing system 1002 may include a variety of servers, sub-systems, programs, modules, logs, and data stores. In particular embodiments, the computing system 1002 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The computing system 1002 may also include suitable components such as network interfaces, security mechanisms, load balancers, failover servers, management-and-network-operations consoles, other suitable components, or any suitable combination thereof.

In particular embodiments, the computing system 1002 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
generating, utilizing a topic generation model, a topic data structure by:
providing a plurality of verbatims to the topic generation model, each verbatim comprising natural language user input text; and
receiving, as output from the topic generation model, the topic data structure comprising topics and keywords, wherein the topic data structure is disconnected from the plurality of verbatims;
generating, utilizing a reverb correlation model, a correlation between a verbatim and a topic of the topic data structure; and
assigning the topic to the verbatim based on the correlation between the verbatim and the topic to connect the verbatim to the topic.

2. The method of claim 1, wherein the topic generation model is a large language model trained to generate a plurality of topics based on a plurality of verbatims, the plurality of topics conveying underlying themes and a plurality of keywords associated with the plurality of topics.

3. The method of claim 1, wherein the reverb correlation model is a large language model trained to recognize topics within verbatims based on semantic associations between the verbatims and the topics.

4. The method of claim 1, further comprising:
receiving additional verbatims comprising additional natural language user input text; and
updating the topic data structure by providing the additional verbatims to the topic generation model.

5. The method of claim 4, further comprising:
determining, based on receiving the additional verbatims, a change in a volume of verbatims satisfies a change threshold by comparing a quantity of the additional verbatims to a quantity of the plurality of verbatims; and
updating the topic data structure based on satisfying the change threshold.

6. The method of claim 1, further comprising generating the topic data structure by:
extracting a plurality of topics from the plurality of verbatims, each topic of the plurality of topics associated with one or more keywords; and
generating the topics by selecting a subset of the plurality of topics based on a relative semantic similarity of the plurality of topics to the plurality of verbatims.

7. The method of claim 1, further comprising generating the topic data structure by:
determining a first subset of topics from a first subset of the plurality of verbatims;
determining a second subset of topics from a second subset of the plurality of verbatims; and
generating the topics by combining the first subset of topics and the second subset of topics.

8. The method of claim 1, further comprising:
generating a heatmap representing correlations between the verbatim and the topic; and
providing the heatmap for display on a client device.

9. The method of claim 1, further comprising:
generating, utilizing a reverb association model, an explanatory report comprising one or more reasons the topic is assigned to the verbatim; and
providing the explanatory report for display on a client device.

10. A system comprising:
at least one processor; and
at least one non-transitory computer readable storage medium comprising instructions that, when executed by the at least one processor, cause the system to:
generate, utilizing a topic generation model, a topic data structure by:
providing a plurality of verbatims to the topic generation model, each verbatim comprising natural language user input text; and
receiving, as output from the topic generation model, the topic data structure comprising topics and keywords, wherein the topic data structure is disconnected from the plurality of verbatims;
generate, utilizing a reverb correlation model, a correlation between a verbatim and a topic of the topic data structure; and
assign the topic to the verbatim based on the correlation between the verbatim and topic to connect the verbatim to the topic.

11. The system of claim 10, further comprising instructions that, when executed by the at least one processor, cause the system to iteratively refine the topic data structure by providing the topics to the topic generation model, wherein iteratively refining the topic data structure modifies the topic data structure by expanding at least one topic into one or more subtopics.

12. The system of claim 10, further comprising instructions that, when executed by the at least one processor, cause the system to assign the topic to the verbatim by determining the correlation between the verbatim and the topic satisfies a threshold semantic similarity metric associated with a semantic relevance of the topic to the verbatim.

13. The system of claim 10, wherein the reverb correlation model is a zero-shot semantic similarity model and further comprising instructions that, when executed by the at least one processor, cause the system to determine, utilizing the reverb correlation model, the correlation between the verbatim and the topic by evaluating a cosine similarity between the verbatim and the topic.

14. The system of claim 10, further comprising instructions that, when executed by the at least one processor, cause the system to:
determine, based on receiving additional verbatims, a quantity of additional verbatims satisfies a change threshold based on the quantity of the additional verbatims; and
update the topic data structure based on satisfying the change threshold.

15. The system of claim 10, further comprising instructions that, when executed by the at least one processor, cause the system to:
determine a first subset of topics from a first subset of the plurality of verbatims;
determine a second subset of topics from a second subset of the plurality of verbatims; and
generate the topics by combining the first subset of topics and the second subset of topics and deduping duplicate topics.

16. A non-transitory computer-readable medium storing instructions that, when executed by at least one processor, cause a computing device to:
generate, utilizing a topic generation model, a topic data structure by:
providing a plurality of verbatims to the topic generation model, each verbatim comprising natural language user input text; and
receiving, as output from the topic generation model, the topic data structure comprising topics and keywords, wherein the topic data structure is disconnected from the plurality of verbatims;
generate, utilizing a reverb correlation model, a correlation between a verbatim and a topic of the topic data structure; and
assign the topic to the verbatim based on the correlation between the verbatim and topic to connect the verbatim to the topic.

17. The non-transitory computer-readable medium of claim 16, wherein:
the topic generation model is a large language model trained to generate a plurality of topics conveying underlying themes and a plurality of keywords associated with the plurality of topics; and
the reverb correlation model is a large language model trained to recognize topics within verbatims based on semantic associations between the verbatims and the topics.

18. The non-transitory computer-readable medium of claim 16, further comprising instructions that, when executed by the at least one processor, cause the computing device to select and train the reverb correlation model based on a target language.

19. The non-transitory computer-readable medium of claim 16, further comprising instructions that, when executed by the at least one processor, cause the computing device to assign the topic to the verbatim based on determining the correlation between the verbatim and the topic satisfies a threshold semantic similarity metric based on a semantic relevance of the topic to the verbatim.

20. The non-transitory computer-readable medium of claim 16, wherein the verbatim is selected from the plurality of verbatims.
